(19) United States
(12) Patent Application Publication
(10) Pub. No.: US 2016/0306515 A1
(43) Pub. Date: Oct. 20, 2016

(54) DIGITAL MEMORY BOOK

(71) Applicant: MR. CHRISTMAS INCORPORATED, New York, NY (US)

(72) Inventors: Leslie Hermanson, Brooklyn, NY (US); Huang Meng-Suen, Kowloon (HK)

(21) Appl. No.: 15/130,213

(22) Filed: Apr. 15, 2016

Related U.S. Application Data
(60) Provisional application No. 62/147,864, filed on Apr. 15, 2015.
(60) Provisional application No. 62/171,557, filed on Jun. 5, 2015.

(51) Int. Cl. G06F 3/0484; G11B 27/036; G06Q 30/06; G11B 27/06; H04B 5/00; H04W 4/00

(52) U.S. Cl. CPC G06F 3/0484; H04B 5/0031; H04W 4/001; G06Q 30/0635; G11B 27/06; G11B 27/036

(57) ABSTRACT

A method of viewing content on a display device includes selecting, by a user using a computing device different from the display device, media content stored on the computing device, editing the selected media content to form edited media content, transferring the selected media content onto the display device, and viewing the edited media content on the display device. The display device may also be pre-loaded with content of a user.

### CROSS REFERENCE TO RELATED APPLICATIONS

This application claims the benefit under 35 U.S.C. §119(e) of U.S. Provisional Patent Application No. 62/147,864, filed Apr. 15, 2015, and titled “Digital Memory Book,” and 62/171,557, filed Jun. 5, 2015, and titled “Digital Memory Book,” the entirety of which are incorporated herein by reference.

### FIELD OF THE INVENTION

This invention relates to an electronic device for viewing and playback of media content, methods for loading media content on the electronic device, and a method for pre-loading content onto the electronic device.

### BACKGROUND OF THE INVENTION

The availability of high-resolution camera functions in smart phones and other portable devices has led to their increased everyday use as an alternative to a separate digital camera. The photos and videos captured from these devices are often uploaded to, and published on, social media sites. However, the expanded use of these devices has led to massive individual collections of captured media content, which makes it difficult to organize and access specific content. Moreover, while the media content may be viewed online once uploaded, it is often difficult to transfer content to another local device, which results in a challenge in locally maintaining a copy of the content for easy access and viewing in an organized manner.

### SUMMARY OF THE INVENTION

In one aspect, the invention relates to a method of viewing content on a display device, comprising selecting, by a user using a computing device different from the display device, media content stored on the computing device; editing the selected media content to form edited media content; transferring the selected media content onto the display device; and viewing the edited media content on the display device.

In another aspect, the invention relates to a method comprising electronically receiving, by a server from a computing device belonging to a third party, a request to fulfill a user's purchase order for an electronic display device having specific user media content pre-loaded thereon; electronically receiving, by a server from a computing device belonging to the third party, data including the specific user content to be pre-loaded on the electronic display device; electronically pre-loading, using a server, the specific user content onto data storage of an electronic display device corresponding to the purchase order; and initiating a delivery of the pre-loaded electronic multimedia device to a destination designated by the user.

These and other aspects of the invention will become apparent from the following disclosure.

### BRIEF DESCRIPTION OF THE DRAWINGS

FIG. 1 shows a digital memory book according to a preferred embodiment of the invention.

FIG. 2 is a schematic diagram of the memory book according to a preferred embodiment of the invention.

FIG. 3 is a schematic diagram of a system according to a preferred embodiment of the invention.

FIGS. 4A-4C are flow diagrams of processes for loading content onto the memory book according to a preferred embodiment of the invention.

FIG. 5 is a flow diagram of a process for editing content according to a preferred embodiment of the invention.

FIG. 6 is a schematic diagram of a system according to a preferred embodiment of the invention.

FIG. 7 is a flow diagram of a process for pre-loading content on a memory book according to a preferred embodiment of the invention.

### DETAILED DESCRIPTION OF THE PREFERRED EMBODIMENTS

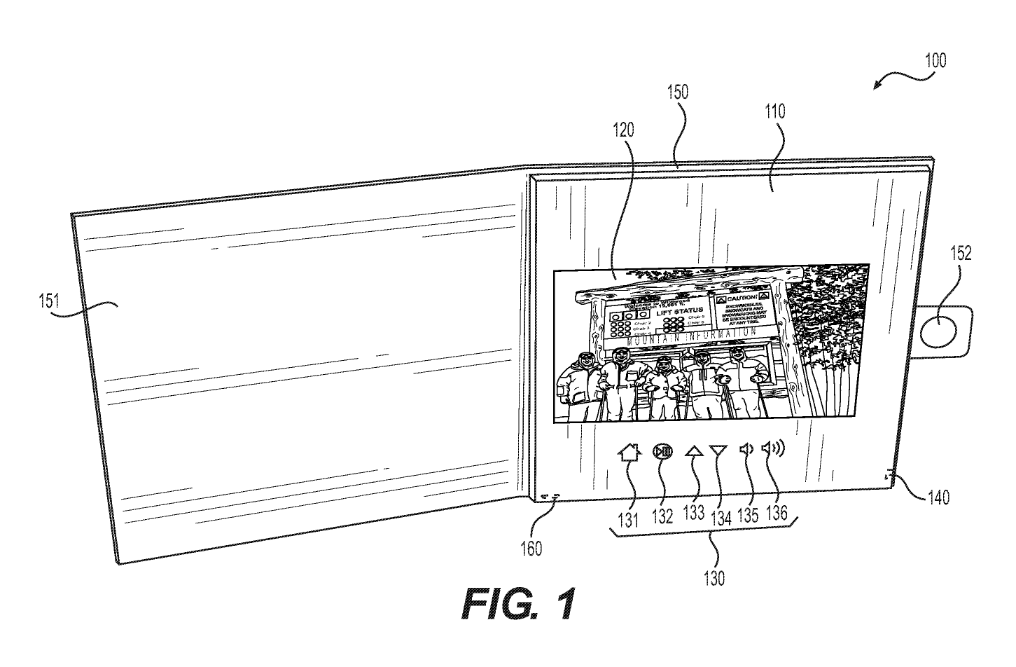

FIG. 1 shows a digital memory book 100, which allows a user to view and playback various media content stored thereon, including, but not limited to, photos, videos, and/or audio. The memory book 100 is portable and preferably handheld, so as to be transported and operated with one or two hands. The memory book 100 includes a housing 110, which supports a display 120, a user input interface 130, and an interface port 140.

The display 120 is preferably a backlit, wide-angle, non-touch-sensitive LCD screen, with a resolution of 1024×600 pixels and a diagonal measurement of 7 inches. It is recognized that the display 120 may be implemented using any suitable display size, resolution, and technology, including those with touch-sensitive functionality, and in such instance, the user input interface 130, or a portion thereof, may be omitted.

The user input interface 130 includes various buttons, such as a home button 131, a play/pause button 132, directional up and down buttons 133, 134, and audio up and down buttons 135, 136. Of course, it is recognized that the buttons 131-136 shown in FIG. 1 are merely one example of button configuration and that any configuration of buttons may be used with the memory book 100. Moreover, the user input interface 130 may even incorporate alternative or additional interface types other than buttons. For instance, the user input interface 130 may include another button that, when pressed, immediately initiates a slide show of photos stored on the memory book 100, or alternatively, a slide show of photos most recently transferred to the memory book 100.

The interface port 140 is used to transfer data between the memory book 100 and another device. The interface port 140 is preferably a form of USB port (e.g., a micro-USB port) for connecting to a USB device. It is recognized that the interface port 140 may utilize any available interface, and may even include two or more interfaces. It is also recognized that the interface port 140 may, in addition to transferring data, be used to power the memory book 100 and/or charge a rechargeable power source in the memory book 100. Of course, it is likewise recognized that a separate port may be provided for powering and recharging the memory book 100.

The memory book 100 also includes a protective cover 150. The protective cover 150 is preferably constructed of an appeasing material, such as leather or synthetic leather, which sufficiently protects the housing 110 from impact and from contamination by foreign matter. Of course, it is recognized that the protective cover 150 may be constructed of other materials including, but not limited to, paper or plastic. The protective cover 150 includes a flip portion 151 and a magnetic clasp 152. The flip portion 151 hinges about a spine of the protective cover 150, so as to open and close the protective cover in the style of a physical book. When closed, the flip portion 151 covers the front face of the housing 110 to provide protection of the display 120 and to prevent activation of the user input interface 130. In addition, the flip portion 151 may be secured in the closed position using the magnetic clasp 152, which is magnetically attracted to a front-facing side of the flip cover 150. By using the magnetic clasp 152, the flip portion 151 is prevented from unintentionally opening and exposing the front face of the housing 151.

The memory book 100 further includes a speaker 160, which is used to output sound for videos and audio content. The speaker 160 may also be used for audio prompts as part of the user interface.

A user begins operating the memory book by initially unclasping the magnetic clasp 152 and opening the flip cover 151. This action activates a sensor (not shown), which automatically activates the display 120 without further user intervention. It is recognized that any suitable sensor may be used, including, but not limited to, a magnetic sensor, a capacitive sensor, a mechanical sensor, an optical sensor, and the like. It is recognized that the memory book 100 may also be configured to be activated by user input, such as by pressing one of the buttons 131-136. The display 120 may also be deactivated by closing the flip cover 151, which oppositely activates the sensor.

Upon activation, the display 120 displays a main screen, allowing the user to select various options using the buttons 131-136. The main screen may include options for the user to select between accessing stored videos, photos, and audio. When the user enters a selection to view videos, the display 120 displays a table-of-contents menu of the videos stored on the memory book 100, including the file names and/or order of the videos. When the user enters a selection to view photos, the available photos stored on the memory book 100 may be displayed. In addition, or as an alternative, the memory book 100 may present an option for the user to initiate a slide show of all photos stored on the memory book 100. In such a case, the memory book 100 may also be configured to select audio stored on the memory book 100 for playback during the slide show, or alternatively, audio stored on the memory book 100 may be automatically selected and may begin playing without separate user intervention. In the case that the user selects the audio option, a listing of the stored audio content is likewise displayed. In the event that the quantity of selectable content items in a particular menu exceeds the available space on the display 120, the memory book 100 allows the user to scroll through multiple screens of selectable content items.

It is recognized that instead of a main screen for navigating different features of the memory book 100, the memory book 100 may alternatively direct the user immediately to the table-of-contents menu to select content for viewing and/or playback.

It is also recognized that the memory book 100 may be configured to permit the viewing of both vertically and horizontally-oriented visual content. This capability allows the visual content to be maximized on the screen 120. Of course, it is recognized that the memory book 100 may be configured to permit viewing only in a single orientation.

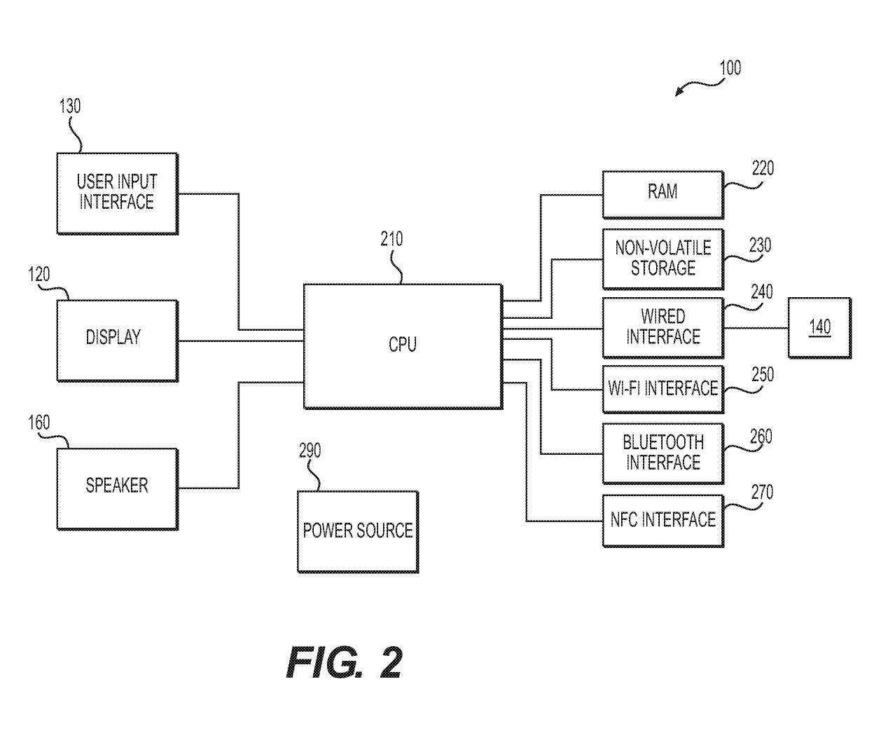

FIG. 2 is a schematic diagram that illustrates the components of the memory book 100. The memory book 100 includes a CPU 210 and RAM 220, which are used to execute computer-readable instructions such as operating system software, thereby providing a user interface for the memory book 100. The user interface permits a user to interact with the memory book 100. The memory book 100 also includes non-volatile storage 230, which is used to store media content to be viewed and played back on the memory book 100. The non-volatile storage 230 is preferably at least 2 gigabytes of flash storage, which provides for storage of approximately 80 minutes of video or 2,000 photos. However, it is recognized that the non-volatile storage may be implemented as any suitable form of non-volatile storage media, including, but not limited to, solid state, magnetic, or optical storage, and may be implemented with any data storage size.

The memory book 100 further includes a wired interface 240, and various wireless interfaces including a Wi-Fi interface 250, a Bluetooth interface 260, and a NFC interface 270. The wired interface 240 is coupled to the interface port 140 located on the housing 110 of the memory book 100, and is preferably a USB interface. Nonetheless, as discussed, it is recognized that the wired interface 240 and corresponding interface port 140 may utilize any available interface, and may even include two or more interfaces. In a preferred embodiment, the wired interface 240 connects the memory book 100 to a computer via USB, to transfer media content from the computer to the memory book.

The Wi-Fi interface 250 connects the memory book 100 to a wireless network for accessing a local area network (LAN) and/or a wide area network (WAN) such as the Internet. The Bluetooth interface 260 connects the memory book 100 with a Bluetooth-enabled device, such as a cellular phone, tablet, laptop computer, or other electronic device. The NFC interface 270 connects the memory book 100 with a near-field communication (NFC) enabled device, such as a cellular phone, tablet, laptop computer, or other electronic device. When the memory book is connected to a computing device (e.g., cellular phone, table, laptop, desktop, or other electronic device) using one of these wireless interfaces, the interface allows the computing device to transfer media content to the memory book 100 and/or control the memory book 100. Of course, it is recognized that the memory book 100 may include additional wireless interfaces, and that any other wireless interface may likewise be integrated with the memory book 100.

The CPU 210 is connected to the non-volatile storage 230, wired interface 240, Wi-Fi interface 250, Bluetooth interface 260, and NFC interface 270 to transfer data with these components. The CPU 210 is also connected to the display 120, so as to control the operation of the display 120. In the case that the display 120 has a touch-sensitive interface, the CPU 210 also receives corresponding touch input signals from the display 120. In addition, the CPU 210 is connected to the user input interface 130 and receives input signals from the user input interface 130, based on user manipulation thereof. Furthermore, the CPU 210 is connected to the speaker 160, so as to play audio.

The memory book 100 additionally includes a power source 290, such as a battery. In a preferred embodiment, the power source 290 is a rechargeable lithium-ion battery having a capacity of 700 mAh, which provides approximately 2 continuous hours of operation for the memory book 100.

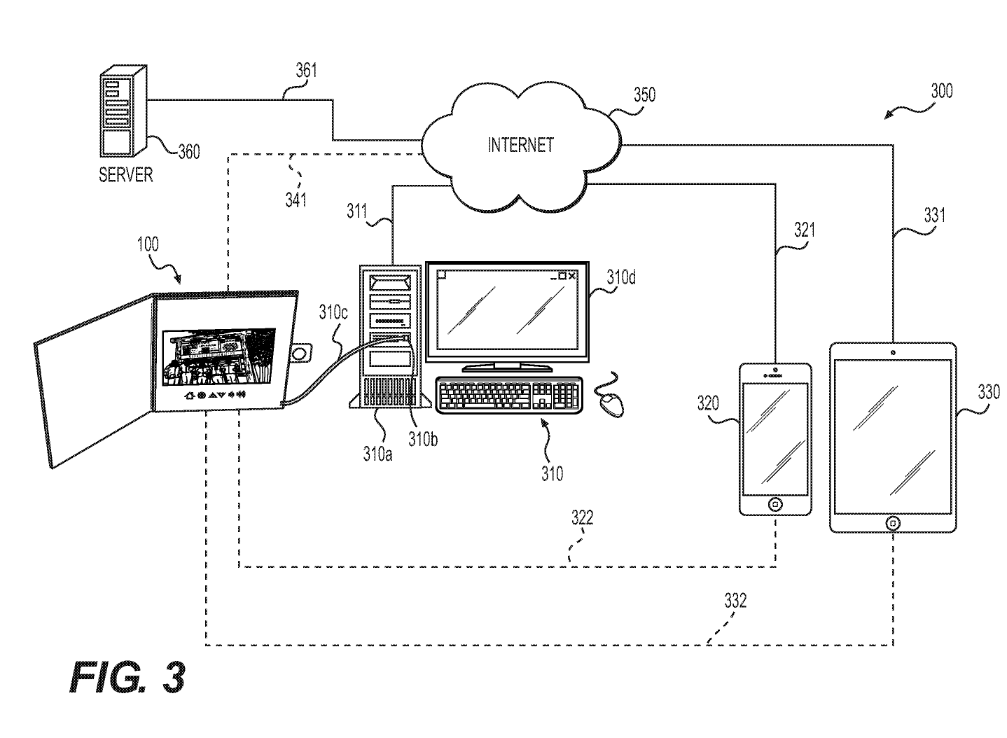

FIG. 3 is a diagram that illustrates a system 300 that includes the memory book 100. The system 300 includes the memory book 100, a computer 310, a cellular phone 320, and a tablet 330, and may involve communications across the Internet 350. The computer 310 includes a main unit 310a, an interface port 310b (which may be provided on the main unit 310a), and a display 310d. It is recognized that while the computer 310 is shown as a desktop, the computer 310 may alternatively constitute a laptop, palmtop, or any other similar computing device. The memory book 100 may be connected to the computer 310 by attaching an interface cable 310c between the interface port 140 of the memory book 100 and the interface port 310b of the computer 310. The interface port 310b and the interface cable 310c are preferably based on the USB standard but, as described with respect to the interface port 140, it is recognized that any available interface type may be used.

The cellular phone 320 is preferably a smartphone (e.g., Apple iPhone®-based or Google Android®-based device) having a connection 321 to the Internet 350 and a connection 322 to the memory book 100. The connection 321 is typically provided as Wi-Fi, while the connection 322 to the memory book 100 may be provided through one or more wired interfaces (e.g., USB) or wireless interfaces (e.g., Wi-Fi, Bluetooth, NFC) in common between the cellular phone 320 and the memory book 100. Using the common interface(s), the cellular phone 320 directly communicates with the memory book 100 via a wired connection (by utilizing the memory book's wired interface 240) and/or wireless connection (by utilizing the memory book's Wi-Fi interface 250, Bluetooth interface 260, and/or NFC interface 270).

The tablet 330 (e.g., Apple iPad®-based or Google Android®-based device) likewise includes a connection 331 to the Internet 350 and a connection 332 to the memory book 100. The connection 331 is typically provided as Wi-Fi, while the connection 332 to the memory book 100 may be provided through one or more wired interfaces (e.g., USB) or wireless interfaces (e.g., Wi-Fi, Bluetooth, NFC) in common between the tablet 330 and the memory book 100. Using the common interface(s), the tablet 330 directly communicates with the memory book 100 via a wired connection (by utilizing the memory book's wired interface 240) and/or wireless connection (by utilizing the memory book's Wi-Fi interface 250, Bluetooth interface 260, and/or NFC interface 270).

The system 300 also includes a server 360, which maintains users' media content and provides various functions including editing of media content. It is recognized that the server 360 may be implemented as a single server or as multiple servers.

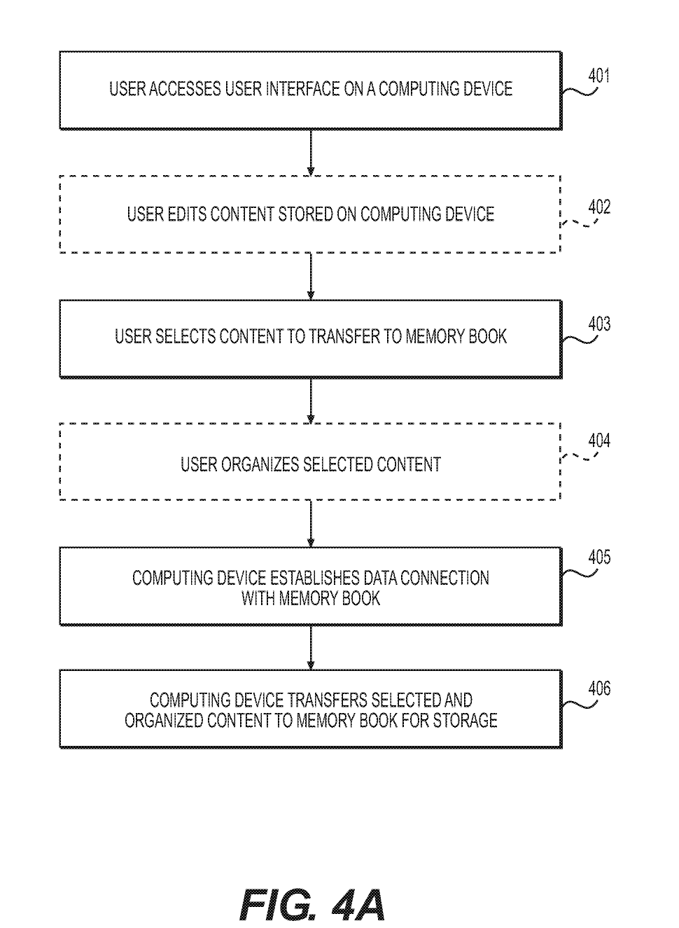

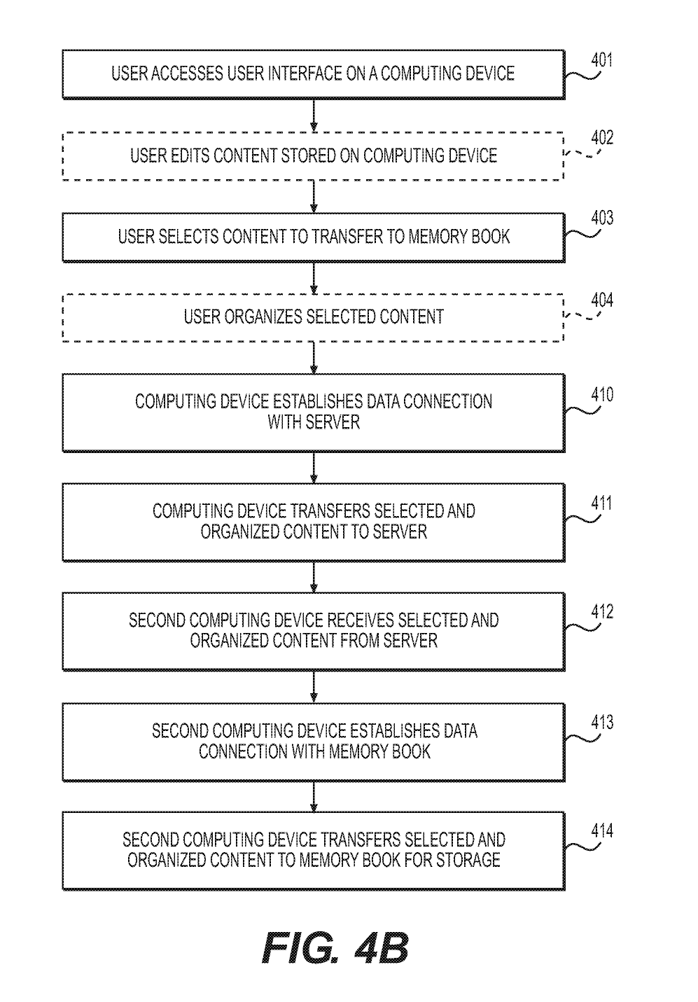

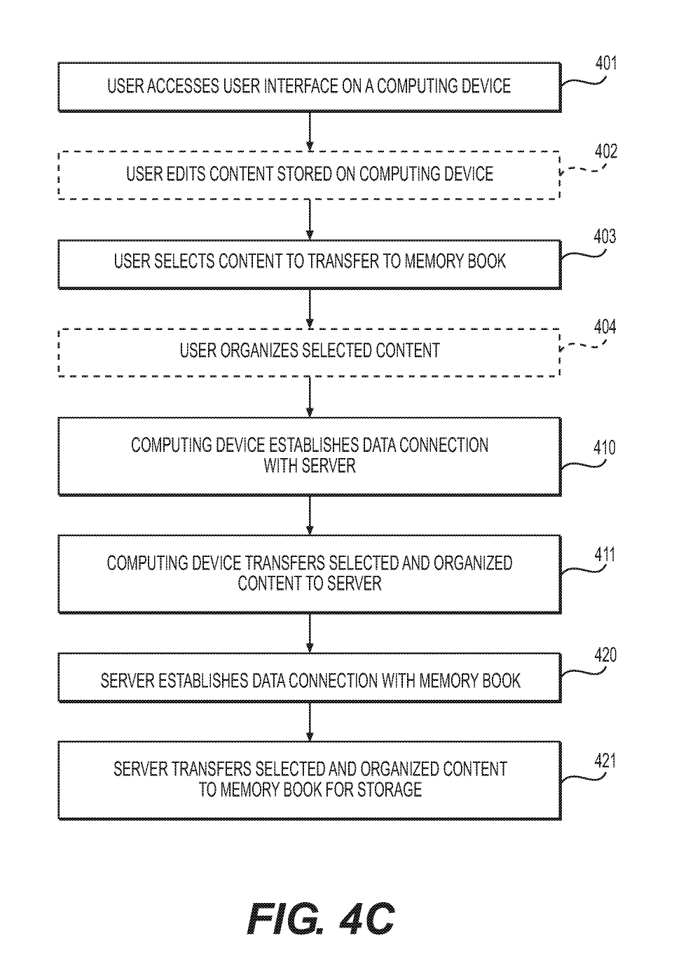

FIGS. 4A-4C illustrate various processes for loading media content onto the memory book 100. In particular, FIG. 4A illustrates a process whereby media content stored on a computing device (e.g., computer 310, cellular phone 320, tablet 330, etc.) is loaded onto the memory book 100 directly from the computing device. In step 401, a user accesses a user interface on a computing device, such as the computer 310, cellular phone 320, or tablet 330. The user interface may be a native interface on the computing device, or an application loaded on the computing device. If the user interface is an application, such application may be pre-loaded on the computing device or subsequently installed (e.g., via an app store).

In step 402, a user is given an option to edit media content stored on the computing device. Various editing processes applicable to this step include, but are not limited to, clipping of video or audio, producing a video based on a series of photos, and/or overlaying of audio content onto video, as will be described later. It is recognized that this step also encompasses the editing of media content which is maintained on cloud storage or on a third-party hosting site and is not actually stored on the computing device. In such instance, the editing of the media content may be performed by another computing device or entity such as the cloud or the third-party host.

In step 403, the user selects specific content stored on the computing device to be transferred to the memory book 100. The specific content may include, but is not limited to, videos, photos, audio, and content edited from step 402.

In step 404, the user optionally organizes the selected content, such that when loaded onto the memory book 100, the content will be presented in the manner specified by the user. Various forms of organization that the user may manipulate in this step include, but are not limited to, designating a viewing order for the content, and arranging the content into a hierarchical structure. A designation of viewing order may be accomplished, for instance, by displaying a list of the selected content on the computing device and providing the user to manipulate the order of items on the list. Alternatively, a user may designate a viewing order by manipulating the filenames of the selected items (e.g., adding a numerical prefix that signifies the viewing order). The arrangement of content into a hierarchical structure may include, but is not limited to, creating various categories (e.g., chapters) and filing the content under the appropriate category or categories. With such organization, users may be able to more efficiently search for and access desired content on the memory book 100.

In step 405, the computing device establishes a data connection with the memory book 100. This may be accomplished in either a wired or wireless manner. In the case of a wired connection, the user may be required to physically connect the computing device to the wired interface 140 of the memory book 100. In the case of a wireless connection, the computing device may form the data connection by, for instance, Wi-Fi, Bluetooth, or NFC, thereby using the Wi-Fi interface 250, Bluetooth interface 260, or NFC interface 270, respectively, of the memory book 100. It is recognized that to establish the wireless connection, the computing device may need to be positioned within wireless range of the memory book 100, with such range varying depending on the particular wireless format being used to establish the connection.

In step 406, the computing device transfers the selected and organized content to the memory book 100, using the data connection established in step 405, and the memory book 100 stores the received content in its non-volatile storage 230.

FIG. 4B illustrates another process whereby media content stored on a computing device (e.g., computer 310, cellular phone 320, tablet 330, etc.) is loaded onto the memory book 100. This process differs from the process of FIG. 4A, in that, instead of transferring the selected content directly from the computing device holding such content, the selected content is first transferred to the server 360, which then transfers the content to the memory book 100 via a second computing device. In a preferred embodiment, the second computing device is the computer 310. Initially, this process performs the same steps 401-404 as described above with respect to FIG. 4A, so the discussion of these steps will not be repeated herein.

Step 410 is performed after the user has optionally organized selected content in step 404. In step 410, the computing device holding the content establishes a data connection with the server 360 over the Internet 350. This may be accomplished via a wired or wireless interface on the computing device, depending on available features of the particular computing device. For instance, if the computing device is a laptop, the data connection may be a wired (e.g., Ethernet) or wireless (e.g., Wi-Fi) connection, and if the computing device is a cellular phone, the data connection may be a Wi-Fi or cellular connection.

In step 411, the computing device transfers the selected and organized content to the server 360, using the data connection established in step 410. As discussed, the content may include, but is not limited to, videos, photos, audio, and edited content.

In step 412, a second computing device receives the selected and organized content from the server 360. As discussed, the second computing device is preferably the computer 310, but may be any suitable computing device capable of establishing a data connection with the memory book 100. The second computing device preferably receives the selected and organized content from the server 360 by initiating a download via a data connection to the Internet 350.

In step 413, the second computing device establishes a data connection with the memory book 100. As with step 405 in FIG. 4A, this may be accomplished in either a wired or wireless manner. In the case of a wired connection, the user may be required to physically connect the second computing device to the wired interface 140 of the memory book 100. In the case of a wireless connection, the second computing device may form the data connection by, for instance, Wi-Fi, Bluetooth, or NFC, thereby using the Wi-Fi interface 250, Bluetooth interface 260, or NFC interface 270, respectively, of the memory book 100. It is recognized that to establish the wireless connection, the second computing device may need to be positioned within wireless range of the memory book 100, with such range varying depending on the particular wireless format being used to establish the connection. In the case that the second computing device is the computer 310, the data connection is preferably a wired connection, and even more preferably a USB connection.

In step 414, the second computing device transfers the selected and organized content to the memory book 100, using the data connection established in step 413, and the memory book 100 stores the received content in its non-volatile storage 230.

FIG. 4C illustrates yet another process whereby media content stored on a computing device (e.g., computer 310, cellular phone 320, tablet 330, etc.) is loaded onto the memory book 100. This process differs from the process of FIGS. 4A and 4B, in that, the selected content is first transferred to the server 360, which then transfers the content directly to the memory book 100. Initially, this process performs the same steps 401-404, 410, and 411 as described above with respect to FIGS. 4A and 4B, so the discussion of these steps will not be repeated herein.

Step 420 is performed after the computing device holding the selected and organized content transfers such content to the server 360 in step 411. In step 420, the server establishes a data connection with the memory book 100. As with step 405 in FIG. 4A and step 412 in FIG. 4B, this may be accomplished in either a wired or wireless manner using a corresponding interface on the memory book 100. In a preferred embodiment, the data connection with the memory book 100 is established across the Internet, via a Wi-Fi connection using the Wi-Fi interface 250.

In step 421, the server transfers the selected and organized content to the memory book 100, using the data connection established in step 420, and the memory book 100 stores the received content in its non-volatile storage 230.

It is recognized that the memory book 100 may utilize one or more of the processes shown in FIGS. 4A-4C, including a combination of such processes, to load content thereon. By having more than one available loading process, the user is provided with more diverse opportunities to load content onto the memory book 100. In addition, it is recognized that while the memory book 100 has been described to include a variety of interfaces, the memory book 100 may include only a subset of these interfaces and/or additional interfaces. For instance, to provide a lower cost, the memory book 100 might only possess a wired USB interface and forego wireless interfaces.

It is also noted that, while describing a first device establishing a data connection with a second device, either one of the first and second device may actually initiate the communications and hand-shaking procedure to establish the data connection, depending on the protocol and/or configuration.

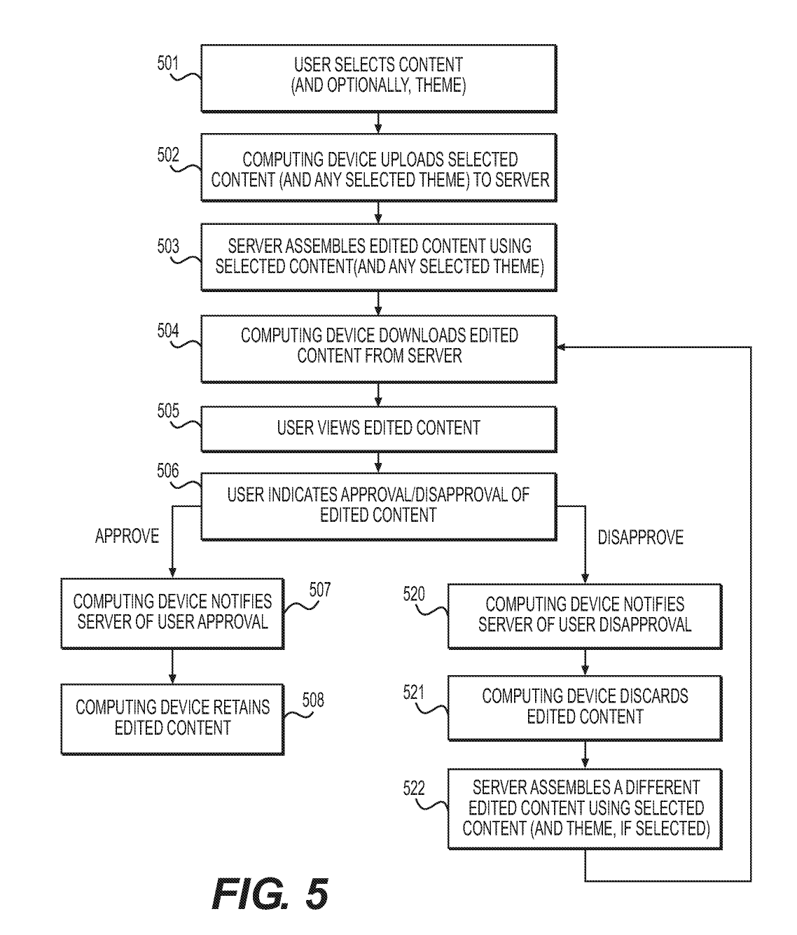

FIG. 5 illustrates a process for editing content, which may be performed as step 402 as shown in FIGS. 4A-4C. In step 501, the user selects content that is stored on a computing device (e.g., computer 310, cellular phone 320, tablet 330, etc.), for editing. The content may include, but not is limited to, video, photos, and/or audio. In the case that the user selects a single content for editing, the desired editing may clip portions of the content, such as when the content is video or audio. In the case that the user selects multiple items of content for editing, the desired editing may combine the selected content items into a single combined content item. For instance, if multiple photos are selected, the desired editing may involve the assembly of a slideshow video displaying each photo for a certain time period. If the user selects different forms of content (e.g., video and audio) for editing, the desired editing may involve the mixing of the content into a single combined form (e.g., overlaying the selected audio onto the audio track of the selected video).

The selection of content in step 501 is not limited to content stored on the computing device. For instance, as an alternative, or in addition, to selecting content stored on the computing device, the user may be presented with an opportunity to browse content available on the server 360 to selection in the editing. As an example, the user may select photos stored on the computing device, and based on browsing of available content on the server 360, select audio content available on the server 360, such that the desired editing produces a slideshow video displaying each photo for a certain time period, with the selected audio content as the corresponding audio track. It is recognized that any suitable form(s) of content may be combined together in various manners.

As another option to selecting multiple items of content, the user may alternatively, or additionally, select a theme in combination with one or more items of content. The theme may define a variety of characteristics surrounding the associated items of content. For instance, a “beach” theme may focus on video portions having an ocean background, and incorporate beach-appropriate audio. As another example, a “family” theme may focus on video portions showing human movement or activity. The particular selected theme may designate a desired editing structure or assembly, or appropriate subject corresponding to the selected item(s) of content. The user may, on the computing device, browse a listing of themes available for selection.

In step 502, the computing device uploads content, which has been selected in step 501 and is stored on the computing device, to the server 360. In addition, if the user has selected content that is maintained on the server 360 (e.g., by browsing content available on the server 360) instead of the computing device itself, the identity of such content is sent to the server 360. Furthermore, if the user has selected a theme, the identity of such theme is sent to the server 360. The uploading process is preferably performed across the Internet 350, although it is recognized that other data networks may be utilized. In addition, it is recognized that cloud storage or third-party hosting may be incorporated, whereby the content and/or theme is maintained by the server 360. In such instance, an identifier of the content and/or theme may be transmitted to the server 360 instead of the actual content and/or theme.

In step 503, the server 360 assembles edited content based on the information provided in step 502. The particular nature of the edited content will depend on the type of content selected by the user, and the theme. For instance, if the user has selected a series of photos as content and has selected a “beach” theme, the edited content may constitute a slideshow video showing each selected photo while playing a beach-themed song. The server 360 may also analyze the selected content to determine relevant or stimulating portions, and trim out the other portions of the content. For instance, if the selected content includes a series of videos, the server 360 may form a single video formed of clips from each of the selected videos.

In step 504, the computing device downloads the edited content from the server 360. It is recognized that the downloading process is preferably performed across the Internet 350, although it is recognized that other data networks may be utilized.

In step 505, the user views the downloaded edited content on the computing device. Again, the edited content may be played as, but not limited to, a video, a photo, or audio.

In step 506, the user indicates, on the computing device, his/her approval or disapproval of the edited content. If the user is satisfied with (i.e., approves of) the edited content, the process proceeds to step 507, whereas if the user is not satisfied with (i.e., disapproves of) the edited content, the process proceeds to step 520.

In step 507, the computing device notifies the server 360 that the edited content has been approved. The server 360 may record such approval information, so as to learn from the user's decision and improve future editing. The server 360 may also store the edited content for future access. In step 508, the computing device retains the downloaded edited content in its storage. Of course, it is recognized that, in the case where cloud storage or third-party hosting is incorporated, the computing device may not permanently store the downloaded edited content in its storage.

In step 520, the computing device notifies the server 360 that the edited content has been disapproved. The server 360 may record such disapproval information, so as to learn from the user's decision and improve future editing. In step 521, the computing device discards the disapproved edited content from its storage. In step 522, the server 360 assembles, in a different style from the previous edit(s), edited content based on the information provided in step 502. For instance, the different style may incorporate the trimming of different portions of selected video, or mixing of a different audio song. After assembling the new version of edited content, the process returns to step 504, so that the new edited content is downloaded to the computing device for user viewing and approval/disapproval.

It is noted that, while the process of FIG. 5 is described with the server 360 performing the assembly of edited content in step 504, some or all of the editing processes may alternatively be performed on the computing device itself. In such instance, the upload and download in steps 503 and 505 may be omitted. It is recognized at least a portion of the steps described in the process of FIG. 5 may be performed using products, services, or technologies operated by Magisto.

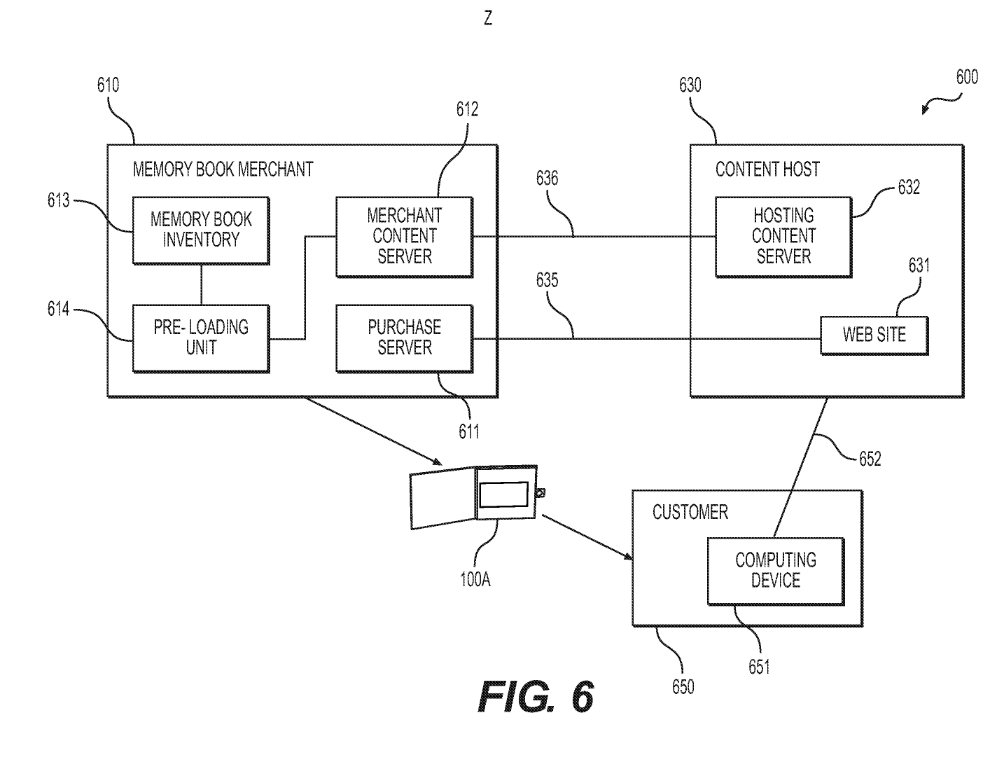

FIG. 6 illustrates a system 600 for delivering a pre-loaded memory book 100-A to a user. The system 600 includes a memory book merchant 610, a content host 630, and a customer 650 of the content host 630. The memory book merchant 610 may be, for instance, a manufacturer or reseller of the memory book 100. The memory book merchant 610 includes a purchase server 611 that manages purchase orders for memory books, a merchant content server 612 that stores media content, a memory book inventory 613, and a pre-loading unit 614. The pre-loading unit 614 connects to a memory book 100, and transfers data to the non-volatile storage 230 of the memory book 100. By transferring a customer's selected content onto a memory book, a pre-loaded memory book 100A is formed. The content host 630 includes a web site 631 for access by users (e.g., customers) of the content host entity as a gateway to manage the customers' content maintained by the content host. The content host 630 also includes a hosting content server 632 for storing users' media content. A customer 650, using a computing device 651 (e.g., computer, cellular phone, tablet), accesses the web site 631 using a data connection 652, to (1) upload content for storage on the hosting content server 632, (2) view existing content stored on the hosting content server 632, and/or (3) download existing content stored on the hosting content server 632.

The web site 631 communicates with the purchase server 611 over a data connection 635, and the hosting content server 632 communicates with the merchant content server 612 over a data connection 636. Preferably, the connections 635, 636, and 652 are encrypted links over the Internet.

It is recognized that the purchase server 611, merchant content server 612, and pre-loading unit 614 may be implemented as a single combined computing unit, as separate computing units, or as a combination thereof. Likewise, the web site 631 and the hosting content server 632 may be implemented as a single combined computing unit or as separate computing units.

The content host 630 may offer various fee-based services to the customer 650, such as producing physical media (e.g., printed photos or video DVDs) of content stored on the hosting content server 632. In addition to these services, the content host 630 may offer the customer an option to purchase a memory book 100A having the customer's content already pre-loaded thereon. With such an option, the customer saves the time and effort required to load content onto a memory book 100 by him-or-herself.

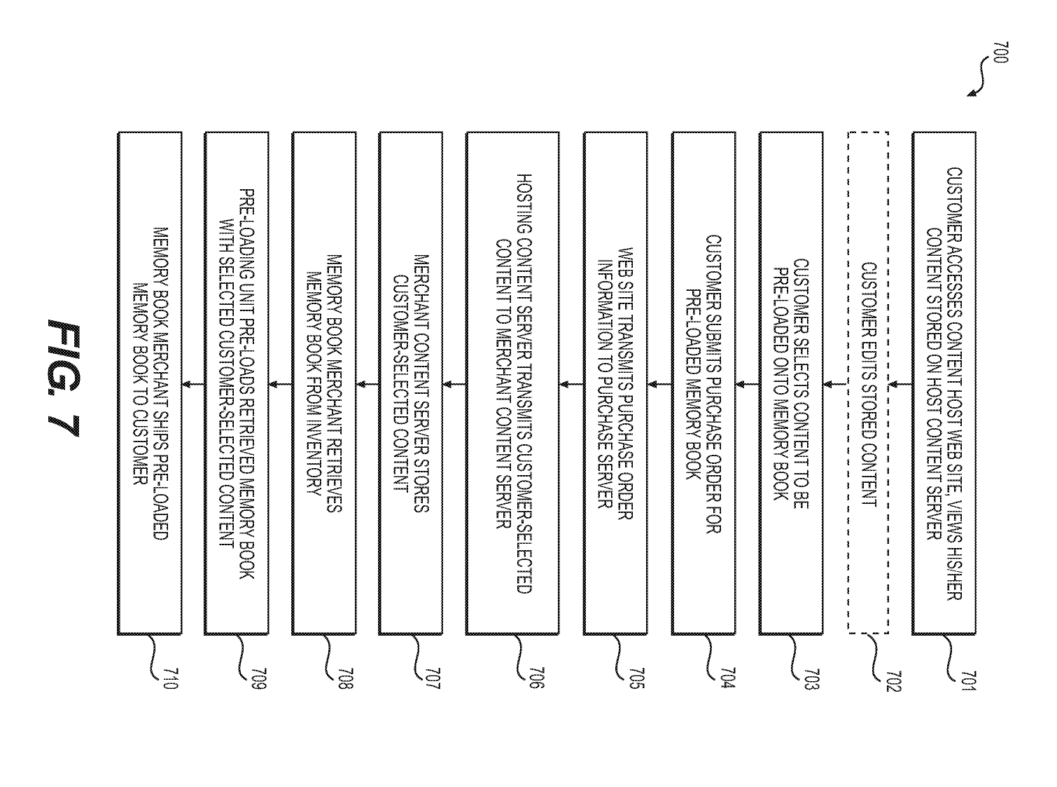

FIG. 7 illustrates a process for providing a pre-loaded memory book 100 to the customer 650. In step 701, the customer 650, using the computing device 651, accesses the web site 631 of the content host 630 and views his/her content stored on the host content server 632, presented in web format by the web site 631. In step 702, using the computing device 651, the customer 650 optionally edits stored content, based on, for instance, the process of FIG. 5. However, it is recognized that the process may differ slightly, to accommodate for the difference that the content is stored with the content host 630 and not on the computing device 651.

In step 703, wishing to purchase a pre-loaded memory book 100A, the customer 650 selects, from his or her content stored on the hosting content server 632, the specific content that the customer wishes to have pre-loaded on the memory book 100A being purchased. This selection process may be accomplished via a web-based interface that displays the customer's stored content for selection. Preferably, the web site 631 is aware of the storage size of the non-volatile storage 230 of a pre-loaded memory book 100A, and notifies the customer 650 if the selected content exceeds such storage size. It is recognized that the customer 650 may select all of his or her content stored on the hosting content server 632, if such selection does not exceed the storage size of the non-volatile storage 230.

In step 704, the customer 650 submits a purchase order to the web site 631 for a pre-loaded memory book 100A, based on the content selected in step 703. The purchase order may contain the customer's information, such as name, billing and shipping addresses, and payment information. The purchase order may also include information for identifying the selected content, or such information may be separately maintained by the web site 631.

In step 705, the web site 631 transmits, to the purchase server 611 via the data connection 635, at least a portion of the purchase order information to the purchase server 611. The memory book merchant 610 interprets the transmitted information as a request to fulfill the order for a pre-loaded memory book 100A. In the case that the customer's payment is to be collected by the content host 630, the customer's payment information within the purchase order may be omitted for transmission. However, the customer's name and shipping address is preferably included among the transmitted information, so that the memory book merchant 610 may utilize such information to deliver the pre-loaded memory book 100A. The transmitted purchase order information may also include an identifier used to identify the particular customer purchase transaction. The transmission in step 705 is preferably encrypted, and an acknowledgement is preferably transmitted from the purchase server 611 to the web site 631 in response to receipt of the transmission.

In step 706, the hosting content server 632 transmits, to the merchant content server 612 via the data connection 636, the media content stored thereon that was selected by the customer in step 703. The transmission may be accomplished by any suitable data transfer method, including, but not limited to FTP or HTTP, and is preferably encrypted. An acknowledgement is preferably transmitted from the merchant content server 612 to the hosting content server 632 in response to receipt of the transmission.

In step 707, the merchant content server 612 stores the customer-selected content received in step 706.

In step 708, the memory book merchant 610 retrieves a memory book from its inventory 613. The memory books stored in the inventory 613 are preferably in a factory state, without individualized content stored thereon. It is recognized that these memory books may be identical in hardware to the memory books 100 discussed above with respect to FIGS. 1 through 5. Of course, it is also recognized that these memory books may be configured differently, so as to facilitate pre-loading of content by the memory book merchant 610. It is also recognized that the memory book may have branded specifically for the content host 630. Furthermore, in a case that the memory book merchant 610 handles purchase orders for pre-loaded memory books 100A from multiple content hosts 630, the memory book inventory 613 may include units of different brands, and step 708 may involve the selection of the appropriately-branded memory book unit from the inventory 613.

In step 709, the pre-loading unit 614 is connected to the memory book retrieved from the inventory 613 in step 708. The pre-loading unit 614 accesses the merchant content server 612 to retrieve the customer-selected content corresponding to the individual customer purchase order, which was stored on the merchant content server 612 in step 707. The pre-loading unit 614 accesses the non-volatile storage 230 of the connected memory book, and transfers the customer-selected content onto the non-volatile storage 230.

In step 710, the memory book merchant 610 ships the pre-loaded memory book 100A to the customer 650. This may be accomplished via any suitable courier or delivery service.

The embodiments discussed herein are examples of preferred embodiments of the present invention and are provided for illustrative purposes only. They are not intended to limit the scope of the invention. Although specific configurations, structures, materials, etc. have been shown and described, such are not limiting. Modifications and variations are contemplated within the scope of the invention, which is to be limited only by the scope of the issued claims.

What is claimed is:

1. A method of viewing content on a handheld display device, the display device including a display, a plurality of physical user inputs, a speaker, and a data interface port, the method comprising:
installing, on a mobile computing device different from the display device, an application that accesses media content stored on the mobile computing device;
selecting, by a user using the application, media content stored on the mobile computing device to be transferred to the handheld display device;
transmitting the media content selected to be stored on the mobile display device, such that the transmitted media content is transferred onto the display device;
selecting, by a user using the application, media content stored on the mobile computing device, wherein the selected media content is to be edited by a server and then stored on the display device;
transmitting, to the server, the media content selected to be edited by the server, such that the server performs editing of the transmitted media content as to form edited media content;
transferring the edited media content onto the display device; and
viewing, on the display device, the media content transferred thereon.

2. The method of claim 1, wherein the media content includes video.

3. The method of claim 2, wherein the editing of media content includes cutting clips of the video.

4. The method of claim 2, wherein the editing of media content includes overlaying audio content on the video.

5. The method of claim 2, wherein the editing of media content includes overlaying graphical content on the video.

6. The method of claim 1, wherein the editing of media content includes assembling a slide show of photos.

7. The method of claim 1, further comprising selecting, by the user using the mobile computing device, a theme,
wherein the editing of the selected media content is performed in accordance with the selected theme.

8. The method of claim 1, wherein the transferring of the edited media content to the display device includes downloading the edited media content from a server.

9. The method of claim 8, wherein the edited media content is transferred to the display device via a wireless interface on the display device.

10. The method of claim 8, wherein the transferring of the edited multimedia content to the display device includes transferring the edited media content from a server to a computer, and transferring the edited media content from the computer to the display device.

11. The method of claim 10, wherein the edited media content is transferred from the computer to the display device via a USB connection.

12. The method of claim 1, wherein the edited media content is directly transferred from the mobile computing device to the display device via a wireless interface on the display device.

13. The method of claim 12, wherein the wireless interface is a Bluetooth interface.

14. The method of claim 12, wherein the wireless interface is a near-field communications interface.

15. A method comprising:
electronically receiving, by a server from a computing device belonging to a third party, a request to fulfill a user's purchase order for an electronic display device having specific user media content pre-loaded thereon, the electronic display device including a display, a plurality of physical user inputs, a speaker, and a data interface port;
electronically receiving, by a server from a computing device belonging to the third party, data including the specific user content to be pre-loaded on the electronic display device;
selecting, from among an inventory of electronic display devices, an electronic display device to be pre-loaded, the selected electronic display device corresponding to the purchase order,
electronically pre-loading, using a server, the specific user content onto data storage of the selected electronic display device; and
initiating a delivery of the pre-loaded electronic multimedia device to a destination designated by the user.

16. The method of claim 15, wherein the specific user content includes content edited by the user.

17. The method of claim 15, wherein the purchase order for the electronic display device is generated in accordance with a submission by the user to the third party.
